(19) United States
(12) Patent Application Publication
(10) Pub. No.: US 2010/0049806 A1
(43) Pub. Date: Feb. 25, 2010

(54) TIME-BASED MESSAGING RULES

(75) Inventors: Thomas Richard Haynes, Apex, NC (US); Phuong Bich Ngo, Raleigh, NC (US)

Correspondence Address: IBM Corporation-Raleigh SWG;c/o Thomas, Raring & Teague, P.C, 536 Granite Avenue, Richmond, VA, 23226, US

(73) Assignee: International Business Machines Corporation, Armonk, NY (US)

(21) Appl. No.: 12/194,147

(22) Filed: Aug. 19, 2008

(51) Int. Cl. G06F 15/16

(52) U.S. Cl. 709/206

(57) ABSTRACT

Embodiments of the present invention may provide the ability for a user to efficiently and automatically organize an email inbox without the lack of attention that can result from prior art methods by providing time-based organization rules and/or organization rules that may be executed after an email message has been viewed.

### BACKGROUND

The present invention relates to electronic messaging.

Communicating by sending and receiving electronic mail (“email”) messages is pervasive in work and personal life. Many email users receive large numbers of email messages every day. Some emails merely convey information, which the recipient may or may not want to retain, while some emails may require one or more actions be taken by the recipient. Due to the volume of messages, it can be difficult to manage the messages to ensure that no important information is lost or necessary actions are neglected. Users might experience an overflow of email messages in the inbox, especially if the user does not have time to organize the email messages.

Currently, there are limited ways to organize email messages in the inbox. One of the known solutions to organize the inbox is to create folders (e.g., in the Lotus Notes email software program) or HTML (hypertext markup language) tags (HTML tags are termed “labels”) (e.g., in many web email programs, such as Google Gmail). This solution enables a user to manually select one or more email messages and place the selected messages into appropriate folder or label. One of the drawbacks of this known solution is that it is inefficient and time-consuming, especially if the rate at which a user receives incoming email is greater than the user's time available to organize the inbox.

Another known solution, which is provided by many existing email software programs, enables a user to create one or more rules to automatically direct new, unread incoming email messages into predetermined existing folders. These rules enable a user, for example, to direct all messages from a specified sender and/or with specified words in the subject line directly into a specified folder, bypassing the inbox. Although this solution allows incoming mails to be immediately organized, this solution can cause a lack of immediate attention because the inbox is bypassed. That is, once the messages are directed into the appropriate folders, the messages might not be seen by the user immediately and/or the user may neglect to read them.

### BRIEF SUMMARY

Embodiments of the present invention may provide the ability for a user to efficiently and automatically organize an email inbox without the lack of attention that can result from prior art methods by providing time-based organization rules and/or organization rules that may be executed after an email message has been viewed. In one embodiment of the invention, a method for applying a predefined action to a received email message comprises determining if the received email message has been viewed by a user, determining if a predefined time period has elapsed since the received email message has been viewed by the user, and applying the predefined action to the received email message if the received email message has been viewed by the user and if the predefined time period has elapsed.

The predefined action may be selected from the group consisting of creating a calendar appointment, creating a task, changing a status of the received message to urgent, adding predefined text to a subject line of the received message, sending a reply message, and notifying a user that the predefined time period has elapsed.

Determining if the received email message has been viewed may comprise determining if the user has viewed the message in a preview pane or determining if the user has opened and closed the message.

In another embodiment of the invention, a method of applying a predefined action to a received email message comprises determining if a predefined time period has elapsed since a predefined event has occurred corresponding to the received email message, and applying the predefined action to the received email message if the predefined time period has elapsed. The predefined action is selected from the group consisting of creating a calendar appointment, creating a task, changing a status of the received message to urgent, adding predefined text to a subject line of the received message, sending a reply message, and notifying a user that the predefined time period has elapsed.

In addition to the methods for applying a predefined action to a received email message, as described above, other aspects of the present invention are directed to corresponding systems and computer program products for applying a predefined action to a received email message.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1-2 are flowcharts of the operation of a method for applying a predefined action to a received email message, in accordance with embodiments of the present invention;

FIG. 3 is a schematic block diagram of a computer network in which embodiments of the present invention may operate; and

FIG. 4 is a schematic block diagram of a computer in the network of FIG. 3.

### DETAILED DESCRIPTION

Embodiments of the invention provide time-based rules for organizing email messages and/or rules that may be implemented after an email message has been viewed. Embodiments of the invention are capable of functioning in at least the following modes:

1. A predefined action (e.g., moving the message into a predetermined folder) is performed after a user has viewed a previously-unread email. This gives the advantage of enabling the user to see the email message in the inbox and ensuring that the message is viewed before any action is performed that may make the message less conspicuous. This mode (as well as the other modes discussed below) may work whether the inbox is set up such that the message is viewed by opening the message or is viewed (such as in a preview pane) when the message is selected. In the former case, the action (e.g., moving the message) would typically be implemented after the message is opened and then closed.

2. A predefined action is performed on an email message that has been previously viewed/opened and a predefined period of time has elapsed since the message was viewed/opened. The predefined period of time may be user-configurable, and may be specified as a specific number of days, hours, months, etc.

3. A predefined action is performed on an email message that has been previously viewed/opened and has now sat unopened for a predefined period of time. The predefined period of time may be user-configurable, and may be specified as a specific number of days, hours, months, etc.

4. A predefined action is performed on an email message that has been in the inbox and unopened for a predefined period of time. The predefined period of time may be user-configurable, and may be specified as a specific number of days, hours, months, etc.

As mentioned above, the predefined action may, although not necessarily, involves moving the email message into a pre-established folder. Other possible actions that may be defined include, for example, creating a calendar appointment, creating a task, changing the status of the message to “urgent,” adding predefined text to the subject line of the message, sending a reply message, and notifying the user such as by popping up a reminder dialog. The user may have several such pre-established folders, each set up to receive email messages having specified properties. Similar to known methods of automatically moving email message, embodiments of the invention may move email messages (or take some other action) based on properties of the email address such as the identity of the sender, whether specified word(s) are in the subject, whether specified word(s) are in the message body, etc.

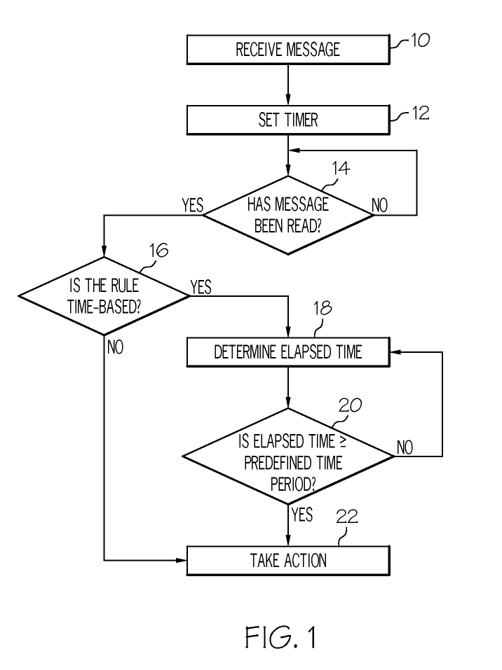

Referring now to FIG. 1, a flowchart of the operation of a method for applying a predefined action to a received email message is illustrated, in accordance with one embodiment of the present invention. FIG. 1 illustrates an embodiment of the invention in which above-described modes 1 and 2 are implemented. In FIG. 1, an email message is received in the email inbox (block 10). A timer is set to begin tracking the elapsed time since receipt of the message (block 12). It is determined if the message has been read by the user (this may be inferred by the user opening and closing the message or by the user clicking on the message if the inbox is set to display a “preview” of the message) (block 14). It is determined if the rule is time-based (block 16), i.e., is the rule set up to move the message into a specified folder (or take some other action) essentially immediately after the message has been read or is the rule set up to move the message (or take some other action) some predefined amount of time after the message has been read. If the rule is not time-based, the predefined action will be taken without delay (other than processing time) (block 22). If the rule is time-based, the elapsed time since receipt will be determined (block 18). The elapsed time will be compared to a user-defined time period (block 20). If the elapsed time is less than the predefined time period, no action will be taken until the elapsed time equals or exceeds the predefined time period. After it is determined that the elapsed time equals or exceeds the predefined time period, the predefined action is taken (e.g., the message is moved into the specified folder) (block 22).

A rule set up to execute as in FIG. 1 may have the following format: MOVE MESSAGE FROM [statement@acmecredit.com] INTO [Credit Card] FOLDER [immediately] AFTER MESSAGE IS VIEWED. In this example and the below examples, the underlined and bracketed information is supplied by the user. Such a rule would follow blocks 10-12-14-16-22 of FIG. 1, and would move a message from the specified sender into the specified folder immediately after the message is read. An alternate rule set up to execute as in FIG. 1 may have the following format: MOVE MESSAGE FROM [statement@acmecredit.com] INTO [Credit Card] FOLDER [7 days] AFTER MESSAGE IS FIRST VIEWED. Such a rule would follow blocks 10-12-14-16-18-20-22 of FIG. 1, and would move a message from the specified sender into the specified folder seven days after the message is read.

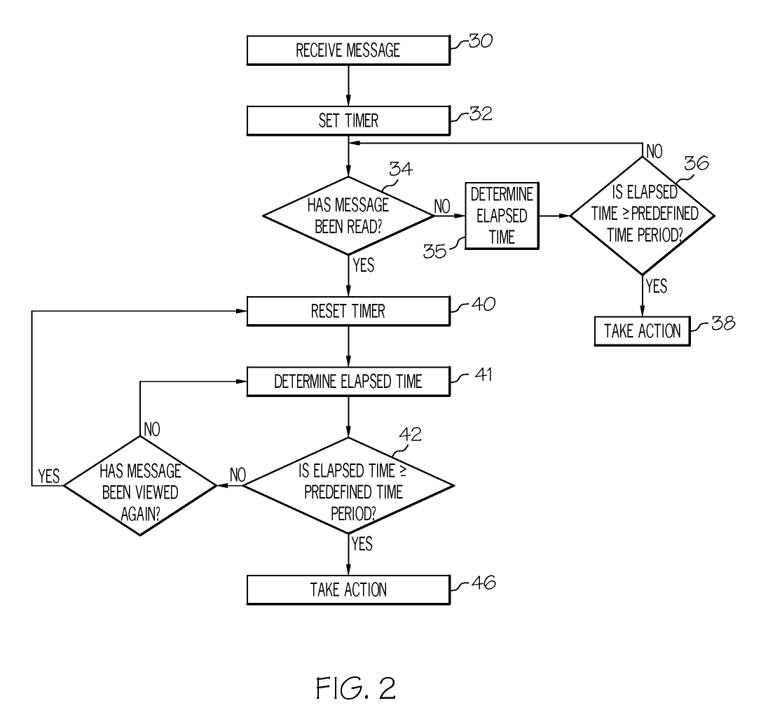

Referring now to FIG. 2, a flowchart of the operation of a method for applying a predefined action to a received email message is illustrated, in accordance with one embodiment of the present invention. FIG. 2 illustrates an embodiment of the invention in which above-described modes 3 and 4 are implemented. In FIG. 2, an email message is received in the email inbox (block 30). A timer is set to begin tracking the elapsed time since receipt of the message (block 32). It is determined if the message has been read by the user (this may be inferred by the user opening and closing the message or by the user clicking on the message if the inbox is set to display a “preview” of the message) (block 34). If the message has not been read, the elapsed time since receipt will be determined (block 35) and compared to a user-defined time period (block 36). If the elapsed time is less than the predefined time period, no action will be taken until the elapsed time equals or exceeds the predefined time period. After it is determined that the elapsed time equals or exceeds the predefined time period, the predefined action is taken (e.g., the message is moved into the specified folder) (block 38). If the message has been read, the timer is reset to enable the timer to track the elapsed time since the message has been read (block 40). The elapsed time since the message has been read will be determined (block 41) and compared to a user-defined time period (block 42). If the elapsed time is less than the predefined time period, it will be determined if the message has been re-read (block 44). If the message has been re-read, the timer will be reset again (block 40). If the message has not been re-read, the elapsed time since the message was read will continue to be compared to the predefined time period until either the message has been viewed again (thereby resetting the timer) or until the elapsed time equals or exceeds the predefined time period. After it is determined that the elapsed time equals or exceeds the predefined time period, the predefined action is taken (e.g., the message is moved into the specified folder) (block 46).

A rule set up to execute as in FIG. 2 may have the following format: MOVE MESSAGE FROM [statement@acmecredit.com] INTO [Credit Card] FOLDER [immediately] IF MESSAGE IS NOT VIEWED WITHIN [7 days] AFTER RECEIPT. In this example and the below examples, the underlined and bracketed information is supplied by the user. Such a rule would follow blocks 30-32-34-35-36-38 of FIG. 2, and would move a message from the specified sender into the specified folder if the message has not been read within seven days of receipt. An alternate rule set up to execute as in FIG. 2 may have the following format: MOVE MESSAGE FROM [statement@acmecredit.com] INTO [Credit Card] FOLDER [7 days] AFTER MESSAGE IS LAST VIEWED. Such a rule would follow blocks 30-32-34-40-41-42-44-46 of FIG. 2, and would move a message from the specified sender into the specified folder seven days after the message is last read (i.e., each time the message is read, the timer is reset).

While FIGS. 1 and 2 illustrate the respective combinations of modes 1-2 and 3-4, it should be appreciated each of these modes could be independently implemented and other mode combinations may be implemented if desired.

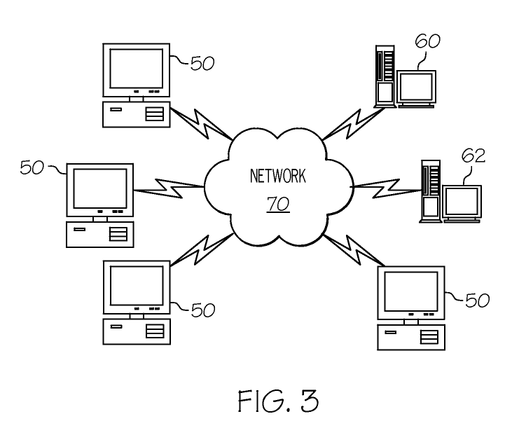

FIG. 3 is a schematic block diagram of a computer network in which embodiments of the present invention may operate. Computers 50 provide processing, storage, and input/output devices executing application programs and the like. Computers 50 may be linked through communications network 70 to other computing devices, including other computers 50 and server computers 60. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. In other embodiments of the present invention, computers 50 and servers 60 may be linked over any suitable communication network. In the system of FIG. 3, computer 50 may execute an email client that includes features of the present invention.

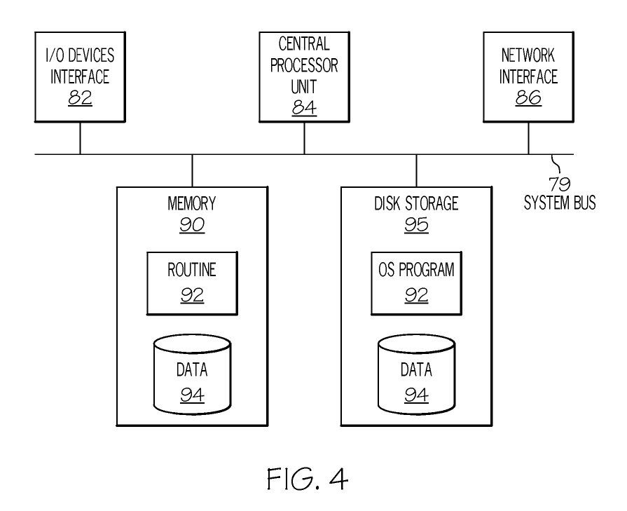

FIG. 4 is a diagram of the internal structure of a computer (e.g., computers 50) in the computer network of FIG. 3. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, etc.) to the computer. Network interface 86 allows the computer to connect to various other devices attached to a network (e.g., network 70 of FIG. 3). Memory 90 provides volatile storage for computer software instructions used to implement an embodiment of the present invention. Disk storage 95 provides non-volatile storage for computer software instructions and data used to implement an embodiment of the present invention. Central processor unit 84 is also attached to system bus 79 and provides for the execution of computer instructions.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method of applying a predefined action to a received email message, the method comprising:
determining if the received email message has been viewed by a user;
determining if a predefined time period has elapsed since the received email message has been viewed by the user; and
applying the predefined action to the received email message if the received email message has been viewed by the user and if the predefined time period has elapsed.

2. The method of claim 1, wherein the predefined action is selected from the group consisting of moving the email message into a predefined folder, creating a calendar appointment, creating a task, changing a status of the received message to urgent, adding predefined text to a subject line of the received message, sending a reply message, and notifying a user that the predefined time period has elapsed.

3. The method of claim 1, wherein determining if the received email message has been viewed by the user comprises determining if the received email message has been viewed by the user in a preview pane.

4. The method of claim 1, wherein determining if the received email message has been viewed by the user comprises determining if the received email message has been opened and closed by the user.

5. A system of applying a predefined action to a received email message, the system comprising:
a processing element configured for determining if the received email message has been viewed by a user, determining if a predefined time period has elapsed since the received email message has been viewed by the user, and applying the predefined action to the received email message if the received email message has been viewed by the user and if the predefined time period has elapsed.

6. The system of claim 5, wherein the predefined action is selected from the group consisting of moving the email message into a predefined folder, creating a calendar appointment, creating a task, changing a status of the received message to urgent, adding predefined text to a subject line of the received message, sending a reply message, and notifying a user that the predefined time period has elapsed.

7. The system of claim 5, wherein determining if the received email message has been viewed by the user comprises determining if the received email message has been viewed by the user in a preview pane.

8. The system of claim 5, wherein determining if the received email message has been viewed by the user comprises determining if the received email message has been opened and closed by the user.

9. A computer program product for applying a predefined action to a received email message, the computer program product comprising at least one computer-readable storage medium having computer-readable program code stored therein, the computer-readable program code comprising:
computer-usable program code for determining if the received email message has been viewed by a user;
computer-usable program code for determining if a predefined time period has elapsed since the received email message has been viewed by the user; and
computer-usable program code for applying the predefined action to the received email message if the received email message has been viewed by the user and if the predefined time period has elapsed.

10. The computer program product of claim 9, wherein the predefined action is selected from the group consisting of moving the email message into a predefined folder, creating a calendar appointment, creating a task, changing a status of the received message to urgent, adding predefined text to a subject line of the received message, sending a reply message, and notifying a user that the predefined time period has elapsed.

11. The computer program product of claim 9, wherein determining if the received email message has been viewed by the user comprises determining if the received email message has been viewed by the user in a preview pane.

12. The computer program product of claim 9, wherein determining if the received email message has been viewed by the user comprises determining if the received email message has been opened and closed by the user.

13. A method of applying a predefined action to a received email message, the method comprising:
determining if a predefined time period has elapsed since a predefined event has occurred corresponding to the received email message; and
applying the predefined action to the received email message if the predefined time period has elapsed;
wherein the predefined action is selected from the group consisting of creating a calendar appointment, creating a task, changing a status of the received message to urgent, adding predefined text to a subject line of the received message, sending a reply message, and notifying a user that the predefined time period has elapsed.

14. The method of claim 13, wherein determining if a predefined time period has elapsed since a predefined event has occurred corresponding to the received email message comprises determining if a predefined time period has elapsed since a user has viewed the message.

15. The method of claim 14, wherein determining if a predefined time period has elapsed since a user has viewed the message comprises determining if a predefined time period has elapsed since a user has viewed the message in a preview pane.

16. The method of claim 14, wherein determining if a predefined time period has elapsed since a user has viewed the message comprises determining if a predefined time period has elapsed since a user has opened and closed the message.

17. The method of claim 13, wherein the predefined event comprises receiving the email message.
